(19) United States
(12) Patent Application Publication
(10) Pub. No.: US 2017/0314331 A1
(43) Pub. Date: Nov. 2, 2017

(54) Apparatus And Method For Orientating, Positioning And Monitoring Drilling Machinery

(71) Applicant: Minnovare Pty Ltd, East Perth WA (AU)

(72) Inventors: Thomas Callum McCracken, Perth WA (AU); Michael Beilby, Perth WA (AU); Michael Ayris, Perth WA (AU)

(21) Appl. No.: 15/523,172

(22) PCT Filed: Oct. 30, 2015
(86) PCT No.: PCT/AU2015/000649

§ 371 Date: Apr. 28, 2017

(30) Foreign Application Priority Data
Oct. 31, 2014 (AU) 2014904391

(51) Int. Cl. E21B 7/04; E21B 7/02; E21B 44/00; E21B 47/024; G01C 19/72; E21C 37/00

(52) U.S. Cl. CPC E21B 7/04; E21B 44/00; E21B 7/027; E21B 47/024; E21B 7/025; E21B 7/046; E21C 37/00; G01C 19/721

(57) ABSTRACT

A drilling machinery orientation apparatus, including an orientation device permanently affixed to, and integral with a structure of, a drilling machine at a point of integration. The orientation device comprises orientation means capable of determining at least an azimuth of a drill rod of the drilling machine prior to drilling a drill hole and determining a change in the azimuth of the drill rod when drilling the drill hole.

### FIELD OF INVENTION

The present invention relates to an apparatus and method for orientating, positioning and monitoring drilling machinery.

More particularly, the present invention relates to an apparatus and method for orientating, positioning and monitoring drilling machinery comprising integrated orientation, positioning and monitoring means.

### BACKGROUND

In mining and drilling operations, the initial orientation of a drill rod often needs to be calculated with a very high degree of accuracy. In blast hole drilling, for example, the initial orientation of the drill rod at the rock face entry point (the so-called “collar point”) determines the direction and course of the resultant drill hole and the position and alignment of the end of the hole (the so-called “toe point”) where the explosive charge will be placed.

Misalignment of drill holes and toe points result in incorrect blasting patterns which can significantly jeopardize the effectiveness, profitability and safety of a mining operation. The fragmentation of rock is fundamental to mining, and by optimising fragmentation significant improvements in waste productivity, mill throughput, lump fines and wall stability can be achieved.

Further, in ground support installation works, accurately aligned drill holes are critical for ensuring that support apparatuses used (which may be, for example, rock bolts, cable bolts, mesh plates, etc.) are positioned and aligned correctly. Misalignments will lead to the rock face being insufficiently secured, which can have dangerous and, in some cases, fatal consequences.

Initial drill hole orientation measurements that are commonly taken include the directional bearing (azimuth) and the inclination (pitch or dip) of the drill hole at its collar point. Inaccurate azimuth measurements dramatically reduce the accuracy of the direction and course of the resultant drill hole. For example, an error of 1 degree in azimuth at a dip angle of 45° degrees will lead to a positional error of 12.3 metres over a 1000 metre drill hole.

Several different methods have been used for measuring the initial orientation of an intended drill hole with varied levels of success. One such method, for example, involves the use of traditional manual surveying stations and equipment to determine the relative drill rod azimuth and dip. This is, however, a time consuming and laborious process. The surveyor must take several measurements and perform numerous calculations to obtain an orientation measurement for each drill hole with an acceptable level of accuracy.

Further, the readings that the surveyor is able to make is often impeded by the limited space available and obstructions that may be present underground. Because of these conditions, the surveyor must take a high number of readings to calculate an accurate orientation.

Further, the drill rig operator must reposition and realign the drilling equipment after each survey measurement is taken for each drill hole, which further compounds the time taken to orientate the drill rod effectively.

Further, surveying round and cylindrical objects, such as a drill rod, at a steep angle with a theodolite is extremely difficult and often results in large variations between the points surveyed along the drill rod. The practice of averaging is typically adopted to compensate for these errors, however the averaged result is often incorrect.

It is also known to use a sequence of reference orientations, in combination with manual surveying techniques, in an effort to improve speed and accuracy of drill alignment operations. Under this approach, a fixed reference line is firstly surveyed and marked into place at a drilling site using conventional manual surveying techniques. An orientation system, typically a laser alignment system, is then used to measure the orientation (azimuth) of the drilling machinery rig body, relative to the fixed reference line. One or more inclinometers attached to the drill mast are then used to align the drill mast to a dip and dump orientation relative to the initial azimuth reference orientation of the drilling machine body until the angle of the drill rod accords to the required drill hole. The accuracy of the final drill rod orientation measurement is, therefore, dependent on the accuracy of the initial reference orientation and each subsequent relative dip and dump angle calculation that is made using the inclinometers. This commonly leads to inaccurate results.

One further method of drill alignment involves the use of a traditional compass to measure azimuth in respect to magnetic north. Such techniques are, however, significantly compromised by the close proximity of metal bodies (for example, the structure of the drilling equipment or the ore body that is being worked on) as the metal greatly influences the compass readings. Further, a magnetic ore body may cause a halo effect on the magnet readings often extremely difficult to detect.

In large scale and high-value drilling operations, drill operators may make use of a dedicated orientation device to measure initial drill hole azimuth and dip. A good example of a commercially available device of this type is disclosed in the Applicant's Australian Innovation Patent No. 2012101210 (“Patent No. 2012101210”). This patent discloses a drilling machine orientation device comprising at least one gyroscope sensing means and control electronics for measuring the orientation of the drilling machine with respect to true north. The gyroscope sensing means may comprise, for example, a mutually orthogonal fibre-optic gyroscope or a set of mutually orthogonal Micro Electrical Mechanical System (MEMS) devices. Further, the orientation device disclosed in Patent No. 2012101210 may additionally comprise at least one set of mutually orthogonal accelerometers that enable changes in the relative orientation and position of the device (and, therefore, the drilling machine) to be calculated.

Commercial applications of dedicated orientation devices and methods, such as is disclosed in Patent No. 2012101210, have considerably improved the accuracy and efficiency of drill alignment operations and they have had a marked disruptive effect on mining and drilling practices. Despite these significant advancements, current applications still suffer from a number of shortfalls. Principally, several steps must still be undertaken, and considerable manual intervention is still required, to measure the initial orientation of an individual drill hole.

As mentioned above, manual methods require a surveyor to setup, calibrate and operate several items of equipment, and perform a range of calculations, for each drill hole. Manual methods, therefore, require a time-consuming “measure, move, measure” methodology to be adopted.

The orientation device disclosed in Patent No. 2012101210 has been successfully implemented in the drilling industry by being mounted externally, using the mounting means disclosed therein, at a position and at an alignment that enables the azimuth and dip of the drill hole entry point to be calculated accurately.

For most drilling applications, in practice the drill rod is the only part of the drilling machine that permits this. Because the drill rod revolves during operation, however, the orientation device must be removed before each hole is drilled and then re-attached and powered up to take the measurements for the next hole. Conducting this exercise inside the confines and darkness of an underground rock face is difficult and time consuming.

Further, modern drilling machines may have as many as three articulated booms connecting to the drill rod to enable dexterous and flexible drilling in confined conditions. Adjusting the azimuth and dip of these individual booms using a mount-on orientation device is cumbersome and time-consuming. This is further exacerbated due to the need to drill a number of relatively short bore holes at a variety of azimuth, dip and dump angles in order to optimise blast patterns.

In blast hole drilling and underground support installations, it is highly desirable that the cycle time between individual drill holes is as short as possible. A large number of drill holes, each having a very precise position, direction and length, must be drilled as quickly as possible. Prior art methods for measuring initial drill hole orientation are still far too time-consuming and are widely regarded in the drilling industry as being a major bottle neck impeding the operational and economic efficiency of downhole operations.

Further, in addition to initial drill hole orientation, it is also highly desirable to accurately measure the starting spatial position of an intended drill hole. In blast hole drilling operations, for example, the final position of a drill hole toe point is a function of the drill hole's initial position and orientation and the length of the drill hole that is cut.

There are numerous techniques known generally that enable a position in three dimensional space to be calculated relative to a fixed reference point of known position. Such techniques, for example, make use of wireless technologies, such as ultra-high frequency (UHF) radio waves (e.g., Bluetooth and Wi-Fi) and radio-frequency identification (RFID), and utilize positioning concepts such as choke and grid points, angle and time of arrival. Despite the proliferation of these techniques, they are yet to be incorporated into a positioning product and used in a way that enables the position of an intended drill hole to be calculated quickly and effectively.

Satellite-based navigation systems, such as the Global Positioning System (GMS), do not work underground and are, therefore, of no value. For these reasons, initial drill hole position is commonly measured using manual surveying methods only which is time-consuming and suffers from the same drawbacks mentioned above in respect to orientating the drill hole.

Further, it is also common in drilling operations to survey various spatial, structural and geological aspects of a drill hole after it has been made. A separate survey tool will be fed inside and along the elongate course of the drill hole using known deployment means to take the required measurements. These survey tools typically employ small rate-based gyroscopes and accelerometers which calculate the final position and orientation data using a “dead reckoning” process.

Briefly, dead reckoning is the process of estimating a current position and/or orientation using a previously determined reference, or fix, position/orientation and advancing the position/orientation based upon changes in measured orientation and speed over an elapsed period of time and course. This process only yields accurate results if very accurate initial position/orientation data is first measured and fed into the sequence of data readings made by a survey tool. Any errors that are present in the initial measurements propagate into all subsequent calculations made using the survey tool. Measuring an accurate initial orientation and position for these purposes is still far too time consuming using existing methods and apparatuses.

Ideally, the drilling operator would survey a drill hole immediately after it has been drilled so that it can determine whether to proceed with the next drill hole or to make adjustments to the present one (for example, because the survey tool may reveal that the path of the drill hole is incorrect) or modify one or more subsequent drill holes. However, this is not practically feasible using existing methods because of the significant time consumed. In practice, survey runs are, therefore, conducted by separate personnel only after a complete sequence or pattern of required drill holes have been made.

Further, it is often desirable in mining and drilling operations to detect and monitor various physical forces acting on and/or phenomena experienced by the drilling machine or the rock face being worked on. For example, it is desirable to detect and measure any adverse levels of vibrations (including vibrations in the sonic spectrum) that may be being generated by the drilling machine due to, for example, drill motor or bearing failure or other mechanical parts.

Presently, in soft soil drilling applications (for example, in horizontal directional drilling applications for provision of underground piping) it is known to place vibration sensors next to a drill head and relay its measurements via communication means to the drilling operator in real time. However, these sensing means are not suited to hard rock drilling applications (such are blast hole or diamond core drilling) and are susceptible to failure as because of their location they are exposed regularly to excessively high levels of vibration, heat and cold, moisture and dust. A means and method for detecting and monitoring a wide range of vibrations and related phenomena that is practical, sensitive and resilient is presently absent in the mining and drilling industry.

The above mentioned issues, shortfalls and requirements arise in respect to many different types of surface and underground drilling, tunnelling and mining operations, including horizontal directional drilling, blast mining, development, exploration and cover hole drilling.

The present invention attempts to overcome, at least in part, the aforementioned disadvantages of prior art drilling machinery orientation, positioning and monitoring methods.

### SUMMARY OF THE INVENTION

In accordance with a first aspect of the present invention, there is provided a drilling machinery orientation apparatus, comprising an orientation device permanently affixed to, and integral with a structure of, a drilling machine at a point of integration, wherein the orientation device comprises orientation means capable of determining:
at least an azimuth of a drill rod of the drilling machine prior to drilling a drill hole; and
a change in the azimuth of the drill rod when drilling the drill hole.

The point of integration may provide that:
a one-to-one relationship exists between the orientation means and the drill rod such that:
   when the azimuth of the drill rod is changed, an azimuth of the orientation means stays fixed relative to the azimuth of the drill rod; and
   when the drill rod is moved, a position of the orientation means stays fixed relative to a position of the drill rod; and
the orientation means does not rotate when the drill rod is rotated about an elongated axis of the drill rod during operation of the drilling machine.

The point of integration may be underneath the drill rod.

The point of integration may be, alternatively, the drill mast of the drilling machine.

The point of integration may be, alternatively, a rotation unit of the drilling machine.

The orientation means may comprise at least one gyroscope sensing means and control electronics.

The gyroscope sensing means may comprise a mutually orthogonal fibre-optic gyroscope.

The gyroscope sensing means may have a tilt angle operation window of up to, and including, plus or minus 180°.

The drilling machinery orientation apparatus may, alternatively, comprise control electronics adapted to, in combination with the gyroscope sensing means, provide azimuth calculations inside a tilt angle operation window of up to, and including, plus or minus 180°.

The gyroscope sensing means may comprise a set of mutually orthogonal Micro Electronic Mechanical System Devices.

The gyroscope sensing means may be adapted to determine the azimuth of the drill rod of the drilling machine with respect to a grid reference angle.

The grid reference angle may be true north.

The orientation means may further comprise at least one set of mutually orthogonal accelerometers for determining a dip angle of the drill rod.

Orientation data generated by the orientation means may be available in real-time.

The orientation data may be used for full or partial autonomous control of the drilling machine, or a part thereof.

In accordance with a second aspect of the present invention, there is provided a drilling machine having the drilling machinery orientation apparatus incorporated into the drilling machine.

In accordance with a third aspect of the present invention, there is provided a method of determining an initial orientation of a proposed drill hole, the method comprising the steps of:
incorporating the drilling machinery orientation apparatus into a drilling machine;
moving the drilling machine to a required position; and
adjusting an azimuth and dip angle of a drill mast of the drilling machine until data provided by the orientation apparatus indicates that a drill rod of the drilling machine is at a required orientation for the proposed drill hole.

In accordance with a fourth aspect of the present invention, there is provided a drilling machinery positioning apparatus, comprising a positioning device permanently affixed to, and integral with a structure of, a drilling machine at a point of integration, wherein the positioning device comprises positioning means capable of determining:
at least a position of a drill rod of the drilling machine prior to drilling a drill hole; and
a change in the position of the drill rod when drilling the drill hole.

The point of integration may provide that:
a one-to-one relationship exists between the positioning means and the drill rod such that:
   when an orientation of the drill rod is changed, an orientation of the positioning means stays fixed relative to the orientation of the drill rod; and
   when the drill rod is moved, a position of the positioning means stays fixed relative to the position of the drill rod; and
the positioning means does not rotate when the drill rod is rotated about an elongated axis of the drill rod during operation of the drilling machine.

The point of integration for the positioning device may be underneath the drill rod.

The point of integration for the positioning device may be, alternatively, the drill mast of the drilling machine.

The point of integration for the positioning device may be, alternatively, a rotation unit of the drilling machine.

The positioning means may calculate the position of the drill rod relative to a fixed reference point of known position.

The positioning means may, alternatively, calculate an absolute position of the drill rod.

The positioning means may employ a wireless positioning technology.

The wireless positioning technology may utilise UHF radio waves.

The wireless positioning technology may, alternatively, utilise one or more radio-frequency identification components.

The wireless positioning technology may, alternatively, comprise a mesh network.

The positioning means may, alternatively, comprise a leaky feeder network.

The positioning means may comprise an inertial navigation system.

Position data generated by the positioning means may be available in real-time.

The position data may be used for full or partial autonomously control of the drilling machine, or a part thereof.

In accordance with a fifth aspect of the present invention, there is provided a drilling machine having the drilling machinery positioning apparatus incorporated into the drilling machine.

In accordance with a sixth aspect of the present invention, there is provided a method of calculating an initial position of a proposed drill hole, the method comprising the steps of:
incorporating the drilling machinery positioning apparatus into the drilling machine; powering up the drilling machine and the positioning means of the positioning apparatus; and
adjusting a position of the drilling machine and a drill mast of the drilling machine until data provided by the positioning means indicates that a drill rod of the drilling machine is at a desired position.

In accordance with a seventh aspect of the present invention, there is provided a drilling machinery orientation system, comprising two or more of the positioning apparatuses integrated into a drilling machine, wherein:
the positioning apparatuses are each disposed at a position wherein they are separated from one another by known distances; and
the position of each positioning apparatus is used to determine an azimuth and dip angle of the drilling machine, or a part thereof.

In accordance with an eighth aspect of the present invention, there is provided a method of determining an initial orientation of a proposed drill hole, the method comprising the steps of:
taking the drilling machinery orientation system;
powering up the drilling machine of the orientation system;
moving the drilling machine to a required position; and
adjusting an azimuth and dip angle of a drill mast of the drilling machine until data calculated using the orientation system indicates that a drill rod of the drilling machine is at a required orientation for the proposed drill hole.

In accordance with a ninth aspect of the present invention, there is provided a drilling machinery monitoring apparatus, comprising a monitoring device permanently affixed to, and integral with a structure of, a drilling machine at a point of integration, wherein the monitoring device comprises monitoring means for monitoring the drilling machine, or a part thereof.

The monitoring means may detect and measure relative displacements in position and angular orientation.

The monitoring means may detect and measure vibrational energy in the form of longitudinal and compression waves.

The monitoring means may comprise at least one set of mutually orthogonal accelerometers.

The monitoring means may additionally comprise at least one microphone.

Monitoring data generated by the monitoring means may be available in real-time.

The monitoring data may be used for full or partial autonomous control of the drilling machine, or a part thereof.

In accordance with a tenth aspect of the present invention, there is provided a drilling machine having the drilling machinery monitoring apparatus incorporated into the drilling machine.

In accordance with an eleventh aspect of the present invention, there is provided a method of monitoring a drilling machine, or a part thereof, the method comprising the steps of:
incorporating the drilling machinery monitoring apparatus into the drilling machine; and
using the drilling machinery monitoring apparatus to monitor one or more physical activities, events or phenomena acting on, or experienced by, the drilling machine or part.

In accordance with a twelfth aspect of the present invention, there is provided a drilling machine having:
the drilling machinery orientation apparatus incorporated into the drilling machine;
the drilling machinery positioning apparatus incorporated into the drilling machine; and
the drilling machinery monitoring apparatus incorporated into the drilling machine.

In accordance with a thirteenth aspect of the present invention, there is provided a method of surveying a drill hole, the method comprising the steps of:
manoeuvring a drilling machine, wherein the drilling machine has the drilling machine orientation apparatus and the drilling machine positioning apparatus incorporated into the drilling machine, such that:
   a position of a drill rod of the drilling machine is adjacent to a collar point of the drill hole; and
   an orientation of the drill rod is aligned with the collar point;
determining the drill rod position using the positioning apparatus;
determining an orientation of the drill rod using the orientation apparatus;
inserting a survey tool into the drill hole;
moving the survey tool along the course of the drill hole one or more times; and
using data readings made by the survey tool, and the drill rod position and orientation, to calculate survey data for the drill hole.

Dead reckoning may be used to calculate the survey data in the method of surveying a drill hole.

In accordance with a fourteenth aspect of the present invention, there is provided a method of drilling one or more drill holes and, subsequently, surveying the, or each, drill hole, the method comprising the steps of:
(a) manoeuvring a drilling machine, wherein the drilling machine has the drilling machine orientation apparatus and the drilling machine positioning apparatus incorporated into the drilling machine, such that:
   a position of a drill rod of the drilling machine is adjacent to a collar point of a first drill hole; and
   an orientation of the drill rod is aligned with the collar point;
(b) determining and recording the drill rod position using the positioning apparatus;
(c) determining and recording the drill rod orientation using the orientation apparatus;
(d) drilling the first drill hole using the drilling machine;
(e) repeating steps (a) to (d) for each subsequent drill hole; and
(f) for at least one drill hole drilled:
   inserting a survey tool into the drill hole;
   moving the survey tool along a course of the drill hole one or more times; and
   using data readings made by the survey tool, and the recorded drill rod position and orientation for the drill hole, to calculate survey data for the drill hole.

In step (a) of the method of drilling one or more drill holes, orientation and position data generated by, respectively, the orientation and positioning apparatus may be used to manoeuvre the drilling machine and its drill rod autonomously.

Dead reckoning may be used to calculate the survey data in the method of drilling one or more drill holes.

The drill rod position and orientation recorded for each drill hole may be stored using electronic storage means permanently affixed to, and integral with the structure of, the drilling machine in the method of drilling one or more drill holes.

In accordance with a fifteenth aspect of the present invention, there is provided a method of calculating an initial orientation and position of a proposed drill hole and, subsequently, verifying the calculated initial orientation and position, the method comprising the steps of:
incorporating the drilling machinery orientation apparatus into a drilling machine comprising a drill mast and drill rod;
incorporating a first and a second positioning apparatus into the drilling machine such that the positioning apparatuses are separated from one another by a known distance;
adjusting an orientation and a position of the drilling machine, and adjusting an orientation and a position of the drill mast, until the orientation means and the first positioning means indicate that the drill rod is at a required orientation and position;
using the first and second positioning means to verify the orientation indicated by the orientation means; and
using the orientation means and the second positioning means to verify the required position indicated by the first positioning means.

In accordance with a sixteenth aspect of the present invention, there is provided a first method of adaptively drilling a plurality of drill hole toe points, each toe point having a position and orientation according to a pre-determined drilling plan, the method comprising the steps of:
(a) manoeuvring a drilling machine, wherein the drilling machine has the drilling machinery orientation apparatus and the drilling machinery positioning apparatus incorporated into the drilling machine, and manoeuvring a drill mast of the drilling machine, such that:
   a position of a drill rod of the drilling machine is adjacent to a collar point of a first drill hole in the pre-determined drilling plan; and
   an orientation of the drill rod is aligned with the collar point;
(b) drilling the first drill hole using the drilling machine;
(c) repeating steps (a) to (b) for subsequent drill holes in the pre-determined drilling plan; and
(d) in respect to any obstruction encountered while drilling an individual drill hole in the pre-determined drilling plan:
   calculating an alternative drill hole collar point, initial orientation and course for the individual drill hole; and
   further manoeuvring the drilling machine and drill mast until the orientation and positioning means indicate that the drill rod is orientated and positioned correctly for the alternative drill hole collar point and initial orientation; and drilling an alternative drill hole which avoids the obstruction and forms a toe point according to the pre-determined drilling plan.

In step (a) of the method of adaptively drilling a plurality of drill hole toe points, orientation and position data generated by, respectively, the orientation and positioning apparatus may be used to manoeuvre the drilling machine and its drill mast autonomously.

In accordance with a seventeenth aspect of the present invention, there is provided a second method for adaptively drilling a plurality of drill hole toe points in a rock body, each toe point having a position and orientation according to a pre-determined drilling plan, the method comprising the steps of:
(a) manoeuvring a drilling machine, wherein the drilling machine has the drilling machinery orientation apparatus and the drilling machinery positioning apparatus incorporated into the drilling machine, and manoeuvring a drill mast of the drilling machine, such that:
   a position of a drill rod of the drilling machine is adjacent to a collar point of a first drill hole in the pre-determined drilling plan; and
   an orientation of the drill rod is aligned with the collar point;
(b) drilling the first drill hole using the drilling machine;
(c) repeating steps (a) to (b) for each subsequent drill hole in the pre-determined drilling plan; and
(d) in respect to an individual drill hole in the pre-determined drilling plan, forming an alternative drill hole by:
   calculating an alternative toe point for the individual drill hole;
   calculating an alternative drill hole collar point, initial orientation and course for the individual drill hole;
   further manoeuvring the drilling machine and drill mast until the orientation and positioning means indicate that the drill rod is orientated and positioned correctly according to the alternative drill hole collar point and initial orientation; and
   drilling the alternative drill hole to form the alternative toe point.

In step (a) of the second method for adaptively drilling a plurality of drill hole toe points, orientation and position data generated by, respectively, the orientation and positioning apparatus may be used to manoeuvre the drilling machine and its drill mast autonomously.

The alternative drill hole that is formed in step (d) of the second method for adaptively drilling a plurality of drill hole toe points may be formed for the purpose of avoiding an obstruction in a rock face of the rock body.

In the second method for adaptively drilling a plurality of drill hole toe points, before a drill hole in the pre-determined drilling plan is drilled, a rock face of the rock body may be scanned at the drill hole's collar point using scanning means to determine whether or not any obstructions are present and likely to stop or hinder the drilling of the drill hole.

The scanning means may comprise a laser, ultra-sonic, infra-red, radar or camera based scanning technology.

In accordance with an eighteenth aspect of the present invention, there is provided a method of adaptively drilling a plurality of drill holes according to a pre-determined drilling plan, the method comprising the steps of:
(a) manoeuvring a drilling machine, wherein the drilling machine has the drilling machinery orientation apparatus and the drilling machinery positioning apparatus incorporated into the drilling machine, and manoeuvring a drill mast of the drilling machine, such that:
   a position of a drill rod of the drilling machine is adjacent to a collar point of a first drill hole in the drilling plan; and
   an orientation of the drill rod is aligned with the collar point;
(b) drilling the first drill hole using the drilling machine according to a desired length and the drilling plan;
(c) using a survey tool to survey the first drill hole drilled and generate survey data relating to orientation of a path and a toe point of the first drill hole;
(d) using the survey data to generate a modified drilling plan for subsequent drill holes in the drilling plan; and
(e) repeating steps (a) to (d) for each subsequent drill hole in the modified drilling plan.

In step (a) of the method of adaptively drilling a plurality of drill holes, orientation and position data generated by, respectively, the orientation and positioning apparatus may be used to manoeuvre the drilling machine and its drill mast autonomously.

The survey data may be generated by dead reckoning in the method of adaptively drilling a plurality of drill holes.

In step (d) of the method of adaptively drilling a plurality of drill holes, the drilling plan may be modified such that:
a position of a collar point of at least one drill hole in the drilling plan is modified;
an initial orientation of at least one drill hole in the drilling plan is modified;
a length of at least one drill hole in the drilling plan is modified;
a toe point of at least one drill hole in the drilling plan is modified;
at least one drill hole in the drilling plan is removed from the drilling plan; or
one or more new drill holes are added to the drilling plan.

In step (d) of the method of adaptively drilling a plurality of drill holes, the drilling plan may be modified for the purpose of:
improving efficiency of a blasting pattern;
improving power and impact of a blasting pattern;
increasing completion speed of a blast hole drilling operation;
optimising order of blast holes in a blasting pattern;
removing a drill hole from the drilling plan which the survey data (aggregate or individual) indicate is redundant;
or
avoiding an obstruction encountered in a rock face.

In accordance with a nineteenth aspect of the present invention, there is provided a method of drilling a plurality of blast drill holes according to a pre-determined blasting pattern, the method comprising the steps of:
(a) manoeuvring a drilling machine, wherein the drilling machine has the drilling machinery orientation apparatus and the drilling machinery positioning apparatus incorporated into the drilling machine, into a Stope;
(b) manoeuvring the drilling machine, and a drill mast of the drilling machine, such that:
   a position of the drill rod of the drilling machine is adjacent to a collar point of a first drill hole in the blasting pattern; and
   an orientation of the drill rod is aligned with the collar point;
(c) drilling the first drill hole using the drilling machine; and
(d) repeating steps (a) to (c) for each subsequent drill hole in the blasting pattern.

The method of drilling a plurality of blast drill holes may comprise an additional step of using a survey tool to survey each drill hole drilled in step (c) after the drill hole is drilled.

The method of drilling a plurality of blast drill holes may comprise an additional step of modifying at least one drill hole in the blasting pattern after a drill hole has been surveyed.

The method of drilling a plurality of blast drill holes may comprise an additional step of inserting an explosive charge into a toe point formed at an end of each drill hole drilled in step (c) using automated deployment means.

The automated deployment means may comprise a hydraulically-powered rod or ram integral with the drilling machine.

The drill rod of the drilling machine may, alternatively, be used by the automated deployment means.

### BRIEF DESCRIPTION OF DRAWINGS

Preferred embodiments of the present invention will now be described, by way of example only, with reference to the accompanying drawings, in which:

FIG. 1 shows an elevated side view of a drilling machine that comprises an orientation apparatus in accordance with one aspect of the present invention, a positioning apparatus in accordance with one further aspect of the present invention and a monitoring apparatus in accordance with one further aspect of the present invention;

FIG. 2 shows a partial enlarged side view of the drilling machine of FIG. 1;

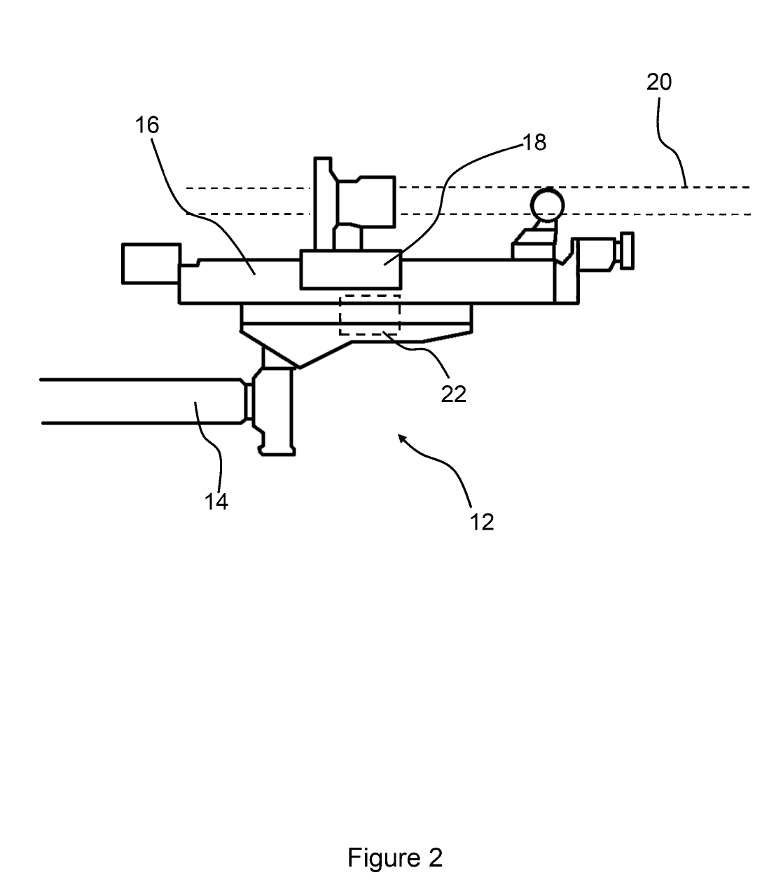

FIG. 3 shows a schematic representation of a blast mining operation wherein a method for drilling a plurality of blast drill holes is being performed in accordance with one further aspect of the present invention;

FIG. 4 shows a schematic representation of a blast mining operation wherein a conventional method for drilling a plurality of blast drill holes is being performed, as is known in the art; and

FIG. 5 shows a further schematic representation of the blast mining operation shown in FIG. 2.

### DETAILED DESCRIPTION OF EMBODIMENTS

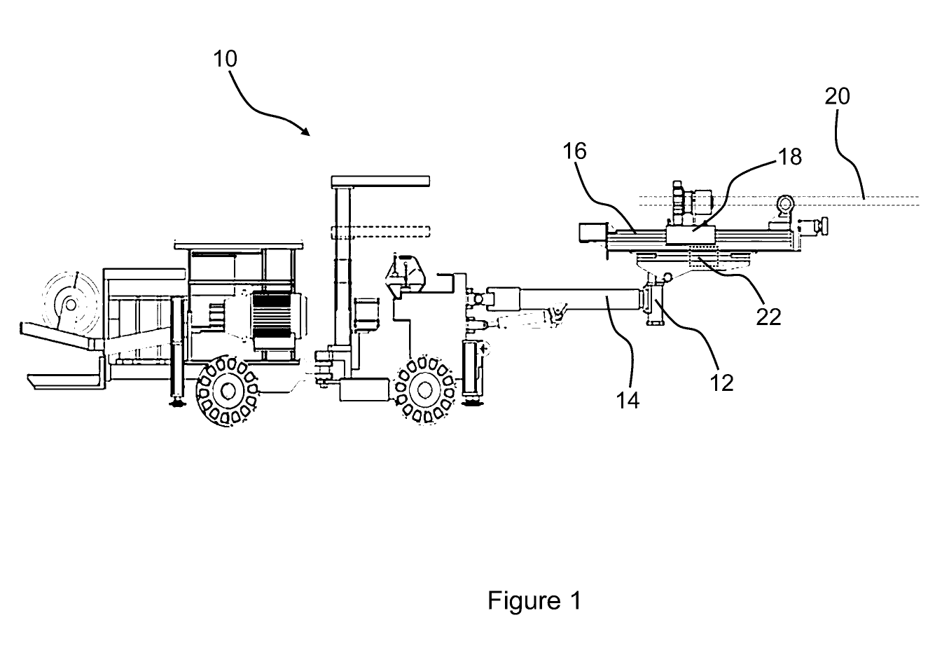

Referring to FIG. 1, there is shown a drilling machine 10 comprising a structure 12 that includes a drill boom 14, drill mast 16 and rotation unit 18. The drill mast 16 and rotation unit 18 are adapted to receive and rotate a drill rod, shown schematically in the Figure by reference numeral 20.

In accordance with a first preferred embodiment of the present invention, the drilling machine 10 comprises an orientation device (not shown) that is permanently affixed to, and is integrated into the structure 12 of, the drilling machine 10 at a point of integration.

The orientation device is capable of determining an azimuth of the drill rod 20 prior to drilling a drill hole in a rock body. Further, the orientation device is capable of determining any changes to the azimuth of the drill rod 20 when the drilling machine 10 is being used to drill the drill hole.

The point of integration, preferably, provides that there is a one-to-one relationship between the respective azimuth and position of the orientation means and the drill rod 20. In this arrangement, when the orientation of the drill rod 20 is changed (for example, when the azimuth of the drill rod 20 is adjusted in order to align the drill rod 20 with the direction of a proposed borehole), the orientation of the orientation means stays fixed, at all times, relative to the drill rod's 20 orientation.

Further, the orientation means is also always at a position that is fixed relative to the drill rod 20. Therefore, when the position of the drill rod 20 is changed (for example, when the drill rod 20 is moved so that it is adjacent to a collar point of the proposed borehole), the position of the orientation means relative to the position of the drill rod 20 does not change.

The point of integration also provides that, when the drilling machine 10 is being used to drill a borehole and the drill rod 20 is rotating, the orientation means does not rotate.

As shown in the Figure, the point of integration is, preferably, a position located underneath the drill rod 20, as shown schematically by reference numeral 22.

Alternatively, the drill mast 16 is the point of integration.

Alternatively, the rotation unit 18 is the point of integration.

It will be appreciated, however, that further alternative points of integration are possible, provided always that a one-to-one relationship exists between the respective orientation and position of the orientation means and drill rod 20 as and when the drill rod 20 is maneuvered during drilling operations.

The orientating means, preferably, comprises at least one gyroscope sensing means (not shown) and control electronics (not shown). Preferably, the gyroscope sensing means is capable of determining the orientation of the drill rod 20 with respect to a grid reference angle. Preferably, the grid reference angle is true north.

The gyroscope sensing means, preferably, comprises a mutually orthogonal fibre-optic gyroscope (not shown). The gyroscope sensing means may, alternately, comprise a set of mutually orthogonal Micro Electronic Mechanical System (MEMS) Devices (not shown). Further, the orientation means additionally comprises at least one set of mutually orthogonal accelerometers (not shown) for measuring a dip angle of the drill rod 20.

Having the orientation means permanently affixed to, and integrated into, the structure 12 of the drilling machine 10 means that the operator may retrieve orientation data on demand, repeatedly and in quick succession.

As mentioned above, current methods used in mining and drilling require several steps and time-consuming manual interventions to take each orientation measurement. Standalone orientation devices that are externally mounted to a drilling machine—for example as disclosed in Patent No. 2012101210—must be re-attached, powered up and re-calibrated for each measurement.

Manual orientation methods require a human surveyor to substantially pre-prepare the relevant mining or drilling site—for example, by calculating and marking physical tide-lines—and make use of slow prism/theodolite based surveying techniques requiring significant human attention for each measurement.

In contrast to the prior art, the integrated and permanently affixed orientation means comprised in the present invention allow for fully automated measurements to be taken without any human intervention at all. Essentially, the data is available to a human drilling operator, or an automated drill control system, in real-time which considerably reduces the cycle time between each drill hole.

Further, having real-time access to orientation data enables the present invention to be used in conjunction with autonomous control systems. The invention may, for example, be used in conjunction with a partial autonomous control system, whereby the orientation data is used by one or more control systems that drive and operate parts of a drilling machine in combination with a human operator. Alternatively, the invention may be used in conjunction with a fully autonomous control system whereby drilling machinery parts are driven and operated solely by one or more control systems.

It is known that many commercially-available north seeking gyroscopes have a limited tilt operating range of no more than plus or minus 90° degrees. That is, once calibrated, the gyroscope is capable of providing accurate azimuth readings provided that it is not tilted at an angle of any more than plus or minus 90° degrees away from its calibration angle about a linear axis running tangential to, and perpendicular to the longitude of, the earth's surface at the calibration point.

For externally-mounted orientation devices, such as disclosed in Patent No. 2012101210, this does not present a problem as the device may be mounted to the drilling machine at a position where the operator can guarantee that the gyroscope's tilt operating angle will not be exceeded. For example, the operator can guarantee this if the device is mounted on the top of the drill rod once the rod has been positioned approximately near to the intended drill hole collar point.

However, as disclosed above, the gyroscope sensing means used in the present invention are permanently affixed to, and incorporated within, the structure 12 of the drilling machine 10. The drill mast 16 may readily need to be tilted at an angle that causes the gyroscope sensing means to be tilted outside of its 90° degree operation window. Therefore, the gyroscope sensing means used in the present invention preferably has a tilt angle operation window of up to and including plus or minus 180° degrees.

Alternatively, the gyroscope sensing means used in the present invention may comprise one or more conventional gyroscopes, each having a 90° degree tilt angle operating range, and control electronics (with related firmware) that enable azimuth readings to be measured accurately at any tilt angle by combining and processing the data received from each of the gyroscopes.

In accordance with a further embodiment of the present invention, the drilling machine 10 comprises a positioning device (not shown) that is permanently affixed to, and is integral with the structure 12 of, the drilling machine 10 at a point of integration.

The positioning device comprises positioning means (not shown) capable of determining a position of the drill rod 20 of the drilling machine 10 prior to drilling a drill hole in a rock body. Further, the positioning means is capable of determining any changes to the position of the drill rod 20 when the drilling machine 10 is being used to drill the drill hole.

Like the point of integration for the orientation means, the point of integration for the positioning means, preferably, also provides that a one-to-one relationship exists between the respective orientation and position of the positioning means and drill rod 20 as and when the drill rod 20 is manoeuvred during drilling operations.

The positioning means, preferably, comprises a positioning device that calculates a position in three-dimensional space. The positioning device, preferably, employs a positioning system that is capable of determining a position relative to a fixed reference point of known position such as, for example, an inertial navigation system (not shown).

Alternatively, the positioning system calculates an absolute position in three-dimensional space.

The positioning device, preferably, uses a positioning technique based on a wireless technology that can operate effectively in an underground environment where, for example, a satellite navigation technology, such as GPS, will not operate.

Preferably, the wireless technology is a UHF radio wave based positioning technology (not shown). Alternatively, the wireless technology uses radio-frequency identification (RFID) technology (not shown). Alternatively, the wireless technology comprises a mesh network (not shown). Alternatively, the positioning technology comprises a leaky feeder network, also known as a “radiating cable” network (not shown).

It will be appreciated, however, that other positioning technologies that calculate an absolute or relative position in three-dimensional space in an underground environment may be used for the purposes of the positioning means in the present invention.

In accordance with a further embodiment of the present invention, the drilling machine 10 comprises two or more of the positioning devices integrated into the drilling machine 10. In this embodiment, the positioning devices are each integrated into parts of the drilling machine 10 at positions that are known distances apart from one another. These positions are then used to determine, via trigonometric calculation, the orientation of the respective drilling machine parts that they are mounted to relative to one another. This methodology may, therefore, be used to calculate an orientation of the drill rod 20 of the drilling machine 10 in lieu of the dedicated orientation means permanently affixed to, and incorporated within the structure 12 of, the drilling machine 10. Equally, this methodology may be used to verify any drill rod 20 orientation readings made using the dedicated orientation means.

Conversely, it will, further, be appreciated that the orientation data obtained using the dedicated orientation means may be combined with position data calculated by one of the positioning devices in order to calculate the position of the other positioning device. This enables any position data obtained using the other positioning device to be verified.

In accordance with a further embodiment of the present invention, the drilling machine 10 comprises a monitoring device (not shown) that is permanently affixed to, and is integral with the structure 12 of, the drilling machine 10 at a point of integration.

The monitoring device comprises monitoring means (not shown) for detecting and measuring relative displacements in position and angular orientation, including displacements caused by vibrational energy in the form of longitudinal and/or compression waves.

The point of integration for the monitoring device provides for a high sensitivity transmission path for vibration signals to the monitoring means.

The monitoring device, preferable, comprises at least one set of mutually orthogonal accelerometers (not shown).

The set of mutually orthogonal accelerometers used by the monitoring means are, preferably, the same as those used by the orientation means. Alternatively, the set of mutually orthogonal accelerometers used by the monitoring means will be different to the set used by the orientation means.

The monitoring means may additionally comprise at least one microphone device (not shown) for detecting the volume and/or timbre of sound waves generated by the drilling machine 10 or rock face being worked on.

Having the monitoring means permanently affixed to, and integrated within, the structure 12 of the drilling machine 10 allows the monitoring means to detect and measure a wide range of physical forces and/or phenomena that may act on or be experienced by the drilling machine 10 or rock face being worked on.

Being in close proximity and contact with the drilling machine 10 means that subtle vibrations caused by, for example, failing mechanical parts, may be detected easily. Similarly, it may also be desirable to detect when certain activities or events have occurred, or will occur, in respect to a particular drilling procedure. For example, when core samples are drilled using a diamond-based drill, a distinctive shock energy wave is generated when lock-in of the core tube is achieved.

Further, distinctive shock energy, vibrations and sound waves are often generated when an active drill breaks through to the intersection of an open void in the rock body or encounters broken ground or rock strata. The integrated monitoring means used in the present invention allow such events to be detected effectively and relayed to the drilling operator.

Further, the monitoring means used in the present invention are advantageously situated at a safe distance away from mechanical parts and conditions that might cause them to fail; for example, the excessive levels of vibration, heat and cold, moisture and dust commonly encountered at a drill head, especially in the case of hard rock drilling.

The integrated orientation, positioning and monitoring means comprised in the present invention dramatically reduces the amount of time that is consumed between drill holes. This, in turn, enables a vast range of drilling capabilities and methodologies not previously envisaged or possible which may be applied in a wide variety of above and below ground drilling commercial operations including, but not limited to, development, exploration and cover-hole drilling operations.

The present invention also, in particular, provides significant improvements in blast mining. In blast mining operations, explosive charges are used to dislodge, breakup and/or excavate rock body that may be desired (e.g., ore body in mining operations) or undesired (e.g., in tunnelling operations).

Typically, a tunnel or small area (known as a “Stope” in certain types of underground blasting operations) is firstly excavated from an area underneath or near to the ore or other rock body to be removed. A drilling machine will then be moved into the Stope area and used to drill a series of drill holes each extending substantially upwards into the ore body in a radial pattern away from the drilling machine's position.

Once drilled, the series of drill holes will commonly resemble a fan pattern in the ore body. Each drill hole has an initial entry point (its collar point) and an end point (its toe point). Explosives are then inserted into each of the toe points and detonated to dislodge and remove the rock body material. The ore body material is then transported away from the Stope and processed.

The position and orientation of each drill hole toe point is of critical importance. Misaligned and poorly positioned drill holes and toe points have drastic consequences for a blast mining operations and may cause problems such as:
“over break”—whereby an incorrect blasting pattern causes unwanted non-core material to be removed by mistake. The non-core material dilutes the mined materials resulting in increased production costs through unnecessary bogging, transportation and crushing, etc.;
“under break” whereby an incorrect blast leaves part of the ore body intact resulting in additional required drill and blast time and production costs;
“bridging”—whereby the blast fails to clear all material, and a large section is left partially suspended in or above the Stope. Additional drill and blast is required to facilitate the removal of the suspended material. This is often conducted via expensive remote-controlled methods due to increased safety risks; and
“fragmentation”—whereby incorrect blasting leads to either too many fines being generated or large fragments of core material that cannot be easily transported. These large fragments must be broken up by secondary blasting, which costs further time and money.

A large number of blast drill holes, each having a very precise position, direction and length, must made for each detonation. Measuring an accurate initial drill hole orientation and position for these purposes is still far too time consuming using existing methods and apparatuses.

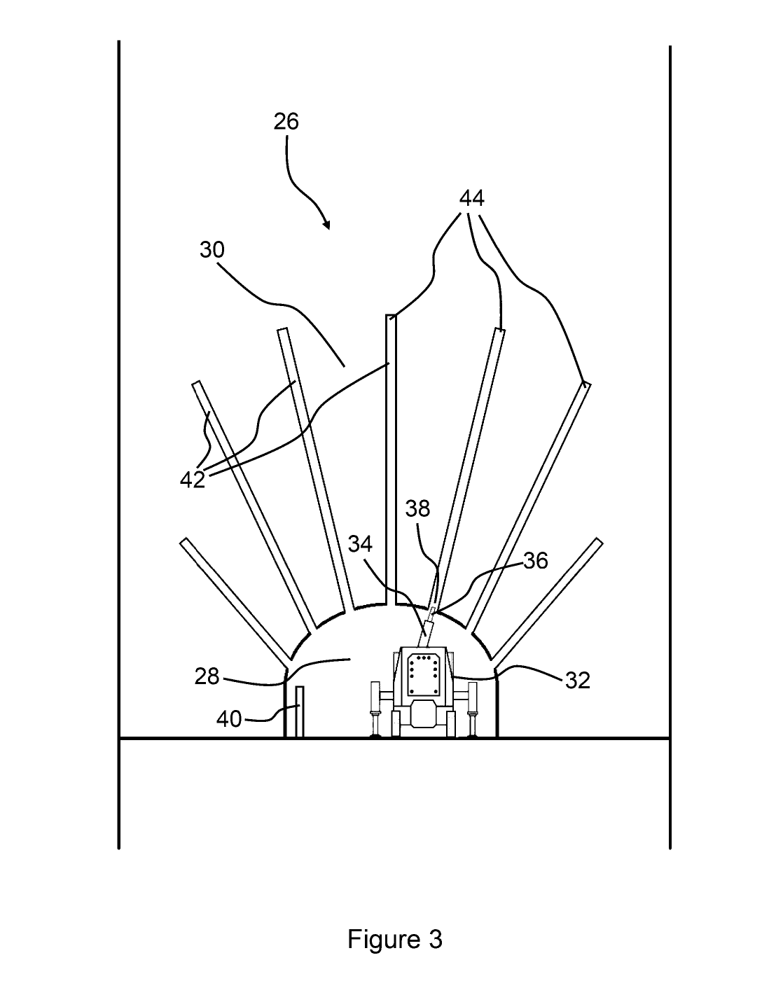

Referring to FIG. 3, there is shown a schematic representation of a method for drilling a plurality of blast drill holes 26 holes in a pre-determined blasting pattern, according to a further embodiment of the present invention.

As shown in the Figure, a Stope 28 is disposed substantially underneath an ore body 30 that is to be mined. A drilling machine 32 having the orientation and positioning means of the present invention incorporated into the drilling machine 32 is, firstly, manoeuvred into the Stope 28.

The drilling machine 32, and a drill mast 34 of the drilling machine 32, are then further manoeuvred until the orientation and positioning means show that a drill rod 36 of the drilling machine 32 is orientated and positioned correctly at the collar point 38 of the first drill hole.

The positioning means may measure an absolute position in three-dimensional space or, alternatively, relative to a fixed reference point 40 of known position. Once aligned and positioned, a first drill hole in the blasting pattern is then drilled according to its desired length. These steps are then repeated until a plurality of drill holes 42 have been drilled according to the required blasting pattern. Each drill hole will comprise a toe point 44 wherein explosive charges will be laid and detonated. As shown in FIG. 3, the plurality of drill holes will commonly form a pattern in the ore body 30 that resembles a fan.

Having the orientation and positioning means permanently affixed to, and integrated within the structure of, the drilling machine 32 allows the plurality of drill holes 42 to be drilled rapidly and with a high degree of accuracy. Accurate position and alignment data is available to the drilling operator, in real-time, immediately after each hole has been drilled.

The invention also allows a drilling operator to adapt the drill hole blasting pattern. The operator may, for example, need to modify the pattern in order to deal with one or more obstacles or impediments present in the rock body while drilling. Equally, the on-demand access to real-time orientation and position data enabled by the present invention allows autonomous and/or remote controlled systems to adapt the blasting pattern according to any obstacles and impediments that may be encountered during drilling.

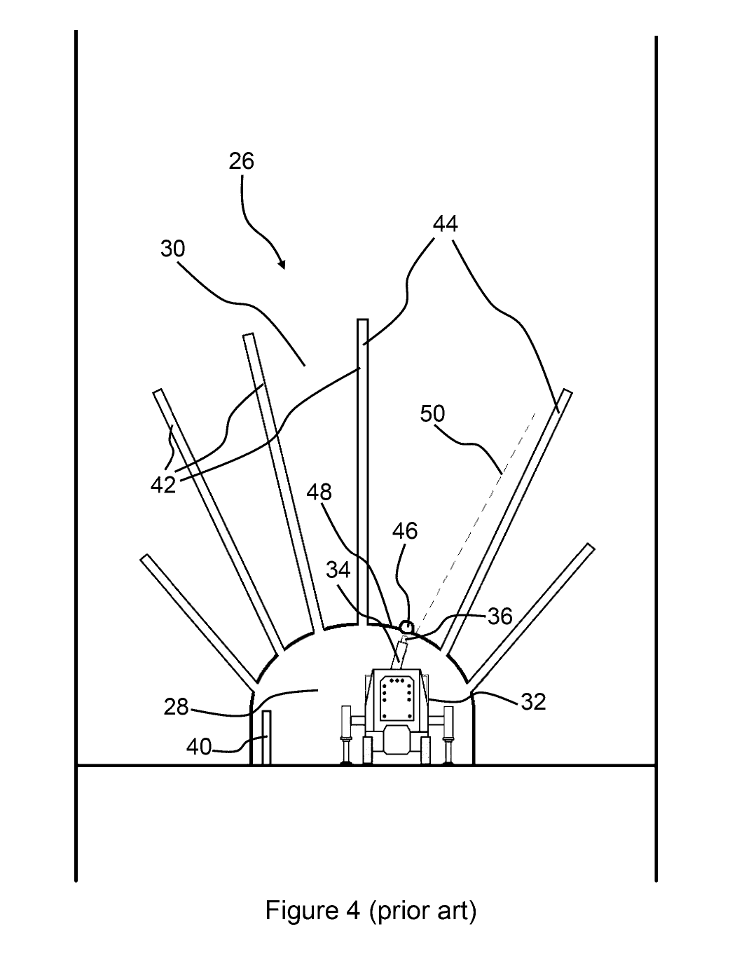

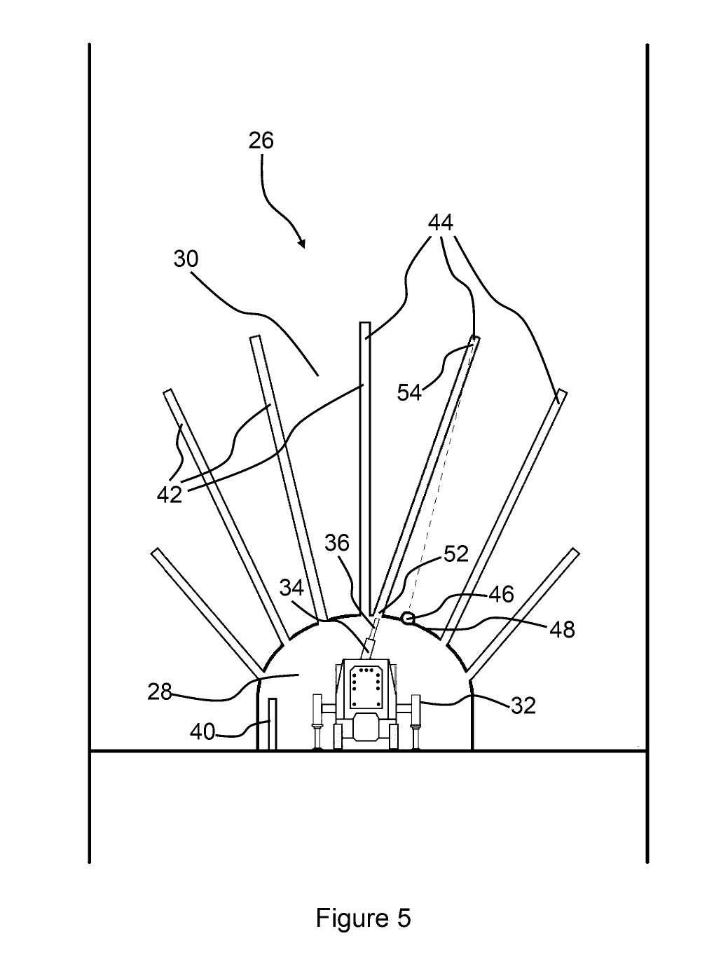

Referring to FIGS. 4 and 5, there are shown alternative depictions of a blast mining operation wherein an obstruction 46 present in the ore body material 30 has been encountered during drilling. The obstruction 46 could, for example, be a ground support apparatus that has been previously installed into a rock face 48 of the Stope 28, such as a rock bolt or mesh plate, or an area of particularly hard rock.

Because of the obstruction 46, a drill hole in the pre-defined fan drilling pattern cannot be drilled. As disclosed above, present methodologies used in tunnelling and mining do not permit accurate orientation and positioning drill rod data to be calculated quickly and without significant human intervention. Because of this, in the situation shown in FIG. 4, in order to avoid the obstruction 46 the drill operator would typically drill an alternative drill hole 50, without re-positioning the drilling machine 32. The alternate drill hole 50 will have an alternative collar point, and resultant alignment and course. This causes the alignment and position of the toe point of the alternative drill hole 50 to be significantly different to the alignment and position initially planned, which can have severe consequences for the blasting operation.

As shown in FIG. 5, in contrast to prior art methodologies, the present invention enables the drilling operator to quickly recalculate an alternative course for the drill hole, effectively on-the-fly, and reposition and realign the drill rod 36 at a new collar point 52 without external human intervention and only minimal delay to the blasting operation. As shown in the Figure, this allows the operator to create the toe point 54 that was originally intended by creating a drill hole having an alternative course. The set of toe points 44 according to the intended fan blasting pattern can, therefore, be achieved regardless of obstructions encountered.

It will be appreciated that the method disclosed herein for drilling a plurality of blast drill holes is of general application and may be used for a wide variety of above and below ground blasting operations. This includes (but is not limited to) Stope blasting, development, exploration and cover hole drilling operations.

It will further be appreciated that the drilling methodologies enabled by the present invention are not limited to blast mining. In accordance with a further aspect of the present invention, there is provided a method of surveying a drill hole. The method comprises the steps of manoeuvring the drilling machine 10 such that a position of the drill rod 20 of the drilling machine 10 is adjacent to a collar point of the drill hole, and such that an orientation of the drill rod 20 is aligned with the collar point. The position and orientation of the drill rod 20 is then determined using the, respectively, positioning apparatus and orientation apparatus of the present invention. A survey tool (not shown) is then inserted into the drill hole and moved along the course of the drill hole one or more times. Data readings made by the survey tool, and the drill rod 20 position and orientation, and then used to calculate survey data for the drill hole, preferably by dead reckoning.

In accordance with a further aspect of the present invention, there is provided a method of drilling one or more drill holes and, subsequently, surveying the, or each, drill hole. The method comprises the steps of manoeuvring the drilling machine 10 such that a position of its drill rod 20 is adjacent to a collar point of a first drill hole, and such that an orientation of the drill rod 20 is aligned with the collar point. The position and orientation of the drill rod 20 is then determined using the, respectively, positioning apparatus and orientation apparatus of the present invention. The first drill hole is then drilled using the drilling machine 10. This process is then repeated for each subsequent drill hole (if any) that needs to be drilled. After a drill hole, or each drill hole, has been drilled, a survey tool is inserted into the drill hole and moved along the course of the drill hole one or more times. Data readings made by the survey tool, and the recorded drill rod 20 position and orientation for the drill hole, and then used to calculate survey data for the drill hole, preferably by dead reckoning.

In accordance with a further aspect of the present invention, there is provided a method of adaptively drilling a plurality of drill hole toe points, each toe point having a position and orientation according to a pre-determined drilling plan. The method comprises the steps of manoeuvring the drilling machine 10 and its drill mast 16 such that a position of the drill rod 20 is adjacent to a collar point of a first drill hole in the pre-determined drilling plan, and such that an orientation of the drill rod 20 is aligned with the collar point. The first drill hole is then drilled using the drilling machine 10. These steps are then repeated in order to drill each subsequent drill hole in the pre-determined drilling plan.

In respect to any obstruction that is encountered while drilling an individual drill hole in the pre-determined drilling plan, an alternative drill hole collar point, initial orientation and course for the individual drill hole is calculated. The drilling machine 10 and its drill mast 16 are then further manoeuvred until the orientation and positioning means indicate that the drill rod 20 is orientated and positioned correctly for the alternative drill hole collar point and initial orientation. The alternative drill hole is then drilled which avoids the obstruction and forms the toe point originally intended according to the pre-determined drilling plan.

In accordance with a further aspect of the present invention, there is provided an alternative method for adaptively drilling a plurality of drill hole toe points in a rock body, each toe point having a position and orientation according to a pre-determined drilling plan. The method comprises the steps of manoeuvring the drilling machine 10 and its drill mast 16 such that a position of the drill rod 20 is adjacent to a collar point of a first drill hole in the pre-determined drilling plan, and such that an orientation of the drill rod 20 is aligned with the collar point. The first drill hole is then drilled using the drilling machine 10. These steps are then repeated in order to drill each subsequent drill hole in the pre-determined drilling plan.

During this process, an individual drill hole, and a corresponding drill hole toe point, in the pre-determined drilling plan may need to be changed. For example, an alternative drill hole may need to be drilled in order to avoid one or more obstructions that are, or will be, encountered in the rock body. In this case, an alternative drill hole is formed by calculating an alternative toe point for the individual drill hole, and calculating an alternative drill hole collar point, initial orientation and course for the new drill hole and toe point. The drilling machine 10 and drill mast 16 re then further manoeuvred until the orientation and positioning means indicate that the drill rod 20 is orientated and positioned correctly according to the alternative drill hole collar point and initial orientation. The alternative drill hole is then drilled to form the alternative toe point.

Before a drill hole in the pre-determined drilling plan is drilled in this method, the rock face of the rock body is, preferably, scanned at the drill hole's collar point using scanning means to determine whether or not any obstructions are present and likely to stop or hinder the drilling of the drill hole and the formation of the toe point. The scanning means used, preferably, comprises a laser, ultra-sonic, infra-red, radar or camera based scanning technology.

The drilling methods enabled by the present invention, as described above, may be applied in a wide variety of above and below ground drilling commercial operations including, but not limited to, development, exploration and cover-hole drilling operations.

Modifications and variations as would be apparent to a skilled addressee are deemed to be within the scope of the present invention.

1-18. (canceled)

19. A drilling machinery positioning apparatus, comprising a positioning device permanently affixed to, and integral with a structure of, a drilling machine at a point of integration, wherein the positioning device comprises positioning means capable of determining:
at least a position of a drill rod of the drilling machine prior to drilling a drill hole; and
a change in the position of the drill rod when drilling the drill hole.

20. A drilling machinery positioning apparatus according to claim 1, wherein the point of integration provides that:
a one-to-one relationship exists between the positioning means and the drill rod such that:
when an orientation of the drill rod is changed, an orientation of the positioning means stays fixed relative to the orientation of the drill rod; and
when the drill rod is moved, a position of the positioning means stays fixed relative to the position of the drill rod; and
the positioning means does not rotate when the drill rod is rotated about an elongated axis of the drill rod during operation of the drilling machine.

21-23. (canceled)

24. A drilling machinery positioning apparatus according to claim 19, wherein the positioning means employs a positioning technology capable of determining a position relative to a fixed reference point of known position.

25. A drilling machinery positioning apparatus according to claim 24, wherein the positioning technology is an inertial navigation system.

26. A drilling machinery positioning apparatus according claim 19 wherein the positioning means calculates an absolute position.

27. A drilling machinery positioning apparatus according to claim 19 wherein the positioning means employs a wireless positioning technology.

28-30. (canceled)

31. A drilling machinery positioning apparatus according to claim 19, wherein the positioning means uses a leaky feeder network.

32. A drilling machinery positioning apparatus according to claim 19 wherein position data generated by the positioning means is available in real-time.

33. A drilling machinery positioning apparatus according to claim 32, wherein the position data is used for partial autonomous control of the drilling machine, or a part thereof.

34. A drilling machinery positioning apparatus according to claim 32, wherein the position data is used for full autonomous control of the drilling machine, or a part thereof.

35. A drilling machine comprising a positioning apparatus according to claim 20 incorporated into the drilling machine

36. A method of calculating an initial position of a proposed drill hole, the method comprising the steps of:
incorporating a positioning apparatus into the drilling machine;
powering up the drilling machine and the positioning means of the positioning apparatus; and
adjusting a position of the drilling machine and a drill mast of the drilling machine until data provided by the positioning means shows that a drill rod of the drilling machine is at a desired position.

37. A drilling machinery orientation system, comprising two or more positioning apparatuses, each positioning apparatus integrated into a drilling machine, wherein:
the positioning apparatuses are each disposed at a position wherein they are separated from one another by known distances; and
the position of each positioning apparatus is used to determine an azimuth and dip angle of the drilling machine, or a part thereof.

38. A method of determining an initial orientation of a proposed drill hole, the method comprising the steps of:
applying a drilling machinery orientation system;
powering up the drilling machine of the orientation system;
moving the drilling machine to a required position; and
adjusting an azimuth and dip angle of a drill mast of the drilling machine until data calculated using the orientation system indicates that a drill rod of the drilling machine is at a required orientation for the proposed drill hole.

39-48. (canceled)

49. A drilling machine, said machine comprising:
a positioning apparatus
an orientation apparatus comprising an orientation device permanently affixed to, and integral with a structure of, the drilling machine at a point of integration, wherein the orientation device comprises orientation means capable of determining at least an azimuth of a drill rod of the drilling machine prior to drilling a drill hole and a change in the azimuth of the drill rod when drilling the drill hole; and
a monitoring device permanently affixed to and integral with a structure of the drilling machine at a point of integration, wherein the monitoring device comprises monitoring means for monitoring the drilling machine, or part thereof.

50. A method of surveying a drill hole, the method comprising the steps of:
maneuvering a drilling machine, wherein the drilling machine comprises a positioning device; and
an orientation apparatus, the orientation apparatus comprising:
an orientation device permanently affixed to, and integral with a structure of, the drilling machine at a point of integration, wherein the orientation device comprises orientation means capable of determining at least an azimuth of a drill rod of the drilling machine prior to drilling a drill hole and a change in the azimuth of the drill rod when drilling the drill hole; and
a positioning apparatus being incorporated into the drilling machine, such that a position of the drill rod of the drilling machine is adjacent to a collar point of the drill hole; and
an orientation of the drill rod is aligned with the collar point;
the method further comprising the steps of:
determining the drill rod position using the positioning apparatus;
determining an orientation of the drill rod using the orientation apparatus;
inserting a survey tool into the drill hole;
moving the survey tool along the course of the drill hole one or more times; and
using data readings made by the survey tool, and the drill rod position and orientation, to calculate survey data for the drill hole.

51. A method of surveying a drill hole according to claim 50, wherein dead reckoning is used to calculate the survey data.

52. A method of drilling one or more drill holes and, subsequently, surveying the, or each, drill hole, the method comprising the steps of:
(a) manoeuvring a drilling machine, wherein the drilling machine comprises:
an orientation apparatus, the orientation device comprises orientation means capable of determining at least an azimuth of a drill rod of the drilling machine prior to drilling a drill hole and a change in the azimuth of the drill rod when drilling the drill hole; and
a positioning apparatus incorporated into the drilling machine, such that
a position of the drill rod of the drilling machine is adjacent to a collar point of a first drill hole; and
an orientation of the drill rod is aligned with the collar point;
(b) determining and recording the drill rod position using the positioning apparatus;
(c) determining and recording a drill rod orientation using the orientation apparatus;
(d) drilling the first drill hole using the drilling machine;
(e) repeating steps (a) to (d) for each subsequent drill hole; and
(f) for at least one drill hole drilled:
inserting a survey tool into the drill hole;
moving the survey tool along the course of the drill hole one or more times; and
using data readings made by the survey tool, and the recorded drill rod collar position and orientation for the drill hole, to calculate survey data for the drill hole.

53. A method according to claim 52, wherein dead reckoning is used to calculate the survey data.

54. A method according to claim 52, wherein the drill rod collar position and orientation recorded for each drill hole is stored using an electronic storage means permanently affixed to, and integral with the structure of, the drilling machine.

55-70. (canceled)
